(19) United States
(12) Patent Application Publication
(10) Pub. No.: US 2019/0100106 A1
(43) Pub. Date: Apr. 4, 2019

(54) DRIVING AROUND-VIEW AUXILIARY DEVICE

(71) Applicant: Hua-chuang Automobile Information Technical Center Co., Ltd., New Taipei City (TW)

(72) Inventors: Yong-Jhou Chen, New Taipei City (TW); Le-Hung Chen, New Taipei City (TW); Meng-Hung Chan, New Taipei City (TW)

(21) Appl. No.: 15/722,282

(22) Filed: Oct. 2, 2017

(51) Int. Cl. B60L 3/12; G06T 1/00

(52) U.S. Cl. CPC B60L 3/12; G06T 1/0007; G06T 2200/32; B60Y 2400/3015; B60Y 2400/92; B60L 2250/16

(57) ABSTRACT

A driving around-view auxiliary device includes a lens group, an image processing module, and a display unit. The lens group can capture a plurality of external images around the vehicle. The image processing module includes an image splicing processing unit and an image delay processing unit. The image splicing processing unit can splice the foregoing external images into a vehicle exterior around-view image. The image delay processing unit is capable of dividing, according to a travel path of the vehicle, the vehicle exterior around-view image that overlaps the travel path into a plurality of delayed images, and sequentially attaching, according to a delay time and starting from the delayed image that is adjacent to the under-vehicle image, the delayed images on an under-vehicle image segmented in the vehicle exterior around-view image. The display unit displays the vehicle exterior around-view image and a total perspective image formed by the under-vehicle image.

### BACKGROUND

### Technical Field

The present invention relates to a driving around-view auxiliary device, and in particular, to a driving around-view auxiliary device that can view a road condition through the vehicle floor.

### Related Art

In the past, in a driving process, whether there are obstacles can be viewed only with assistance of internal and external rearview mirrors. Safeties of the internal and external rearview mirrors are widely castigated because the internal and external rearview mirrors have innate dead angles. As the development of technologies of image identification, a driver can easily view a road condition outside the vehicle by splicing and synthesizing images into a top-view around-view image by using a plurality of lenses (usually are a front lens, a back lens, a right lens, and a left lens), and playing the around-view image through a screen.

Referring to FIG. 1, FIG. 1 is a schematic diagram of a conventional driving around view. After the foregoing front lens, back lens, right lens, and left lens respectively capture images outside the vehicle, a front image I_{F}, a back image I_{B}, a left image I_{L}, and a right image I_{R} are spliced and synthesized into a top-view around-view image I_{A}. Moreover, an under-vehicle image I_{U} segmented in the around-view image I_{A} is usually processed by using a black image, and finally a virtual vehicle image I_{C} is superposed on the black image.

Therefore, the conventional technologies still merely resolve requirements on fields of view of a vehicle exterior around view. However, the under-vehicle image I_{U} processed by using a black image cannot enable the driver to see clearly the road condition under the vehicle floor, and matters for regret such as: a vehicle wheel falls into a ditch or a little animal under the vehicle is mistakenly crushed may occur to the driving.

### SUMMARY

On the basis of the foregoing problems, the present invention provides a driving around-view auxiliary device, and an under-vehicle image may be seen through by using an image delay processing technology, so that a road condition under a vehicle floor may be easily viewed.

A driving around-view auxiliary device of the present invention is applicable to a vehicle, where the device mainly includes a lens group, an image processing module, and a display unit. The lens group can capture a plurality of external images around the vehicle. The image processing module includes an image splicing processing unit and an image delay processing unit. The image splicing processing unit can splice the foregoing external images into a vehicle exterior around-view image. The image delay processing unit is capable of dividing, according to a travel path of the vehicle, the vehicle exterior around-view image that overlaps the travel path into a plurality of delayed images, and sequentially attaching, according to a delay time and starting from the delayed image that is adjacent to the under-vehicle image, the delayed images on an under-vehicle image segmented in the vehicle exterior around-view image. The display unit can display the vehicle exterior around-view image processed by means of the image delay and a total perspective image formed by the under-vehicle image.

### BRIEF DESCRIPTION OF THE DRAWINGS

FIG. 1 is a schematic diagram of a conventional driving around view;

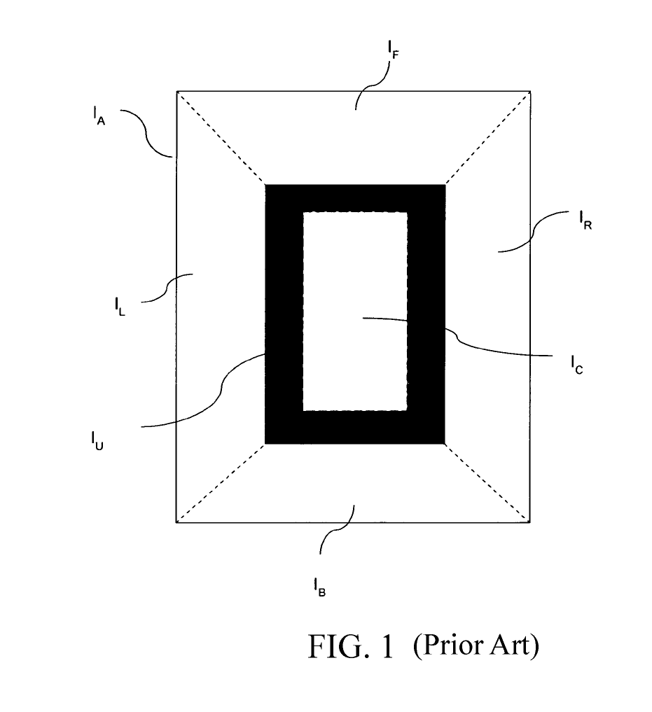

FIG. 2 is a block diagram of a driving around-view auxiliary device according to the present invention;

FIG. 3 is a schematic diagram of a first step of displaying of a driving around-view auxiliary device according to the present invention; and

FIG. 4 is a schematic diagram of a second step of displaying of a driving around-view auxiliary device according to the present invention.

### DETAILED DESCRIPTION

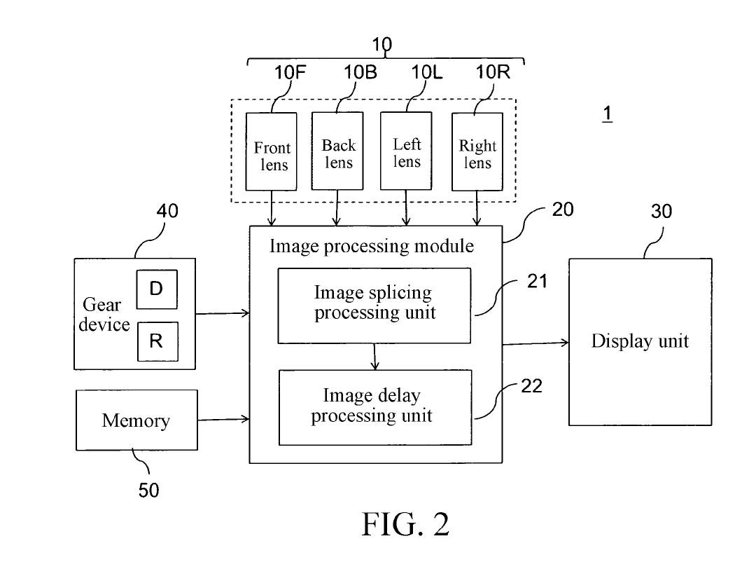

Referring to FIG. 2, FIG. 2 is a block diagram of a driving around-view auxiliary device according to the present invention. In this embodiment, a driving around-view auxiliary device 1 is applicable to a vehicle. The device mainly includes a lens group 10, an image processing module 20, and a display unit 30. The lens group 10 includes a plurality of lenses, where these lenses are respectively disposed at different positions around the vehicle, to respectively capture a plurality of external images around the vehicle. Using this embodiment as an example, the lens group 10 includes a front lens 10F, a back lens 10B, a left lens 10L, and a right lens 10R, separately. The image processing module 20 is electrically connected to the lens group 10, and includes an image splicing processing unit 21 and an image delay processing unit 22. The display unit 30 is electrically connected to the image processing module 20, and is configured to output and display an image.

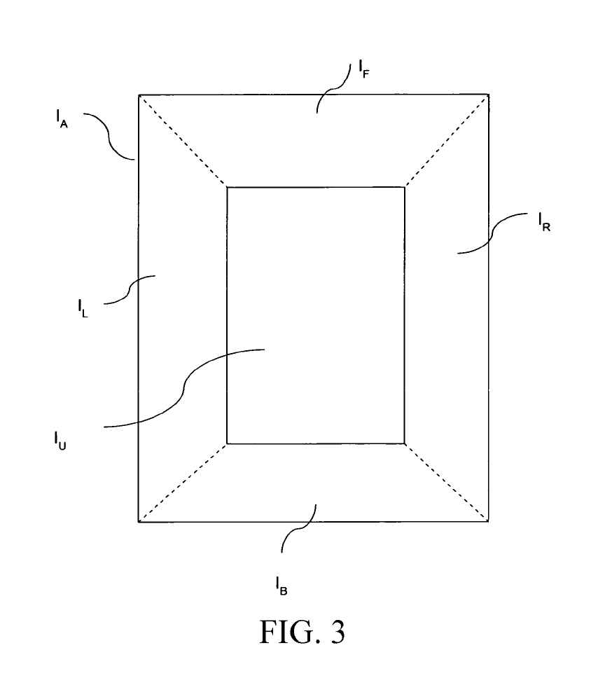

Referring to FIG. 2 and FIG. 3, FIG. 3 is a schematic diagram of a first step of displaying of a driving around-view auxiliary device according to the present invention. In this embodiment, when a driving around view is displayed, first, in a first step, through a front image I_{F}, a back image I_{B}, a left image I_{L}, and a right image I_{R} that are captured by the front lens 10F, the back lens 10B, the left lens 10L, and the right lens 10R, the foregoing external images are spliced and synthesized into a vehicle exterior around-view image I_{A} by using the image splicing processing unit 21, and an under-vehicle image I_{U} is segmented in the vehicle exterior around-view image.

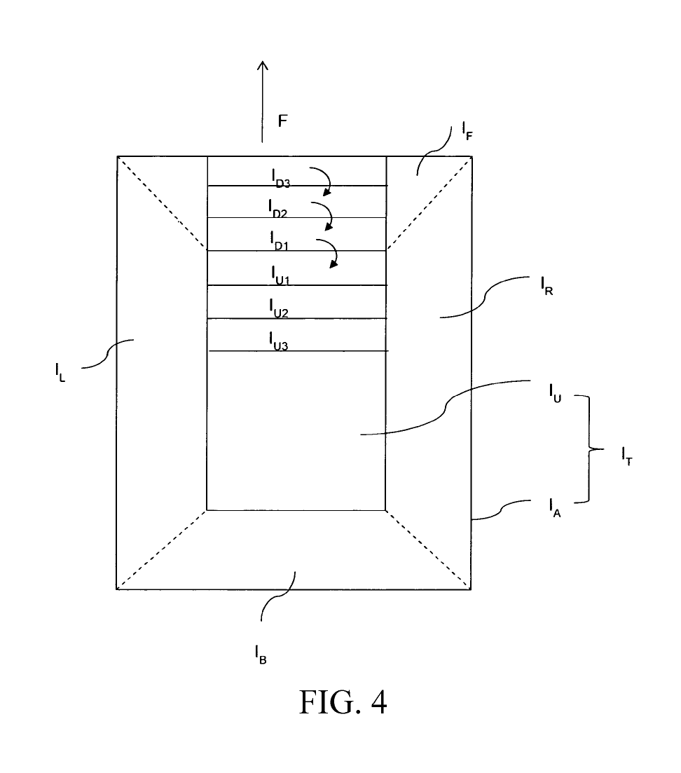

Referring to FIG. 2 and FIG. 4, FIG. 4 is a schematic diagram of a second step of displaying of a driving around-view auxiliary device according to the present invention. As stated above, subsequently in a second step, the image delay processing unit 22 may divide, according to a travel path F of the vehicle, the vehicle exterior around-view image I_{A} that overlaps the travel path F into a plurality of delayed images (I_{D1-D3}), and sequentially attach, according to a delay time, the delayed images on the under-vehicle image I_{U} starting from the delayed image I_{D1} that is adjacent to the under-vehicle image I_{U}.

Using FIG. 4 as an example, the travel path F of the vehicle is moving forward, and these delayed images (I_{D1-D3}) are divided by the front image I_{F}. The delay time may be several seconds, and a quantity of these delayed images obtained through division may be the same as a quantity of the seconds of the delay time. For example, the delay time is three seconds, and the delayed images (I_{D1-D3}) divided by the front image I_{F} are divided into three sheet-like images. However, it may be learned from this embodiment that these delayed images (I_{D1-D3}) may be designed to be at equal distances to an axial border of the under-vehicle image I_{U}, so that the delayed images (I_{D1-D3}) may be aligned with and attached on the under-vehicle image I_{U}.

In detail, the delay time is preset to be 3 seconds in this embodiment, and the delayed images divided by the front image I_{F} are 3 sheets. When the travel path F of the vehicle is moving forward, if it is supposed that a time at which splicing and synthesizing of the vehicle exterior around-view image I_{A} is finished is the first second, from a subsequent second second on, the delayed image I_{D1} of the front image I_{F} is attached on an under-vehicle image I_{U1}, and the delayed image I_{D2} of the front image I_{F} covers the delayed image I_{D1}, and the delayed image I_{D3} covers the delayed image I_{D2}; from the third second on, the delayed image I_{D1} is attached on an under-vehicle image I_{U2}, and the delayed image I_{D2} of the front image I_{F} is covered at a position of the delayed image I_{D1} at the second second; and this is kept for several seconds in this logic (for example, at a subsequent fourth second, the delayed image I_{D1} is attached on an under-vehicle image I_{U3}, a subsequent image is attached on a next image, and the rest can be deduced by analogy), until the under-vehicle image I_{U} is full attached with the delayed images.

Referring to FIG. 2 and FIG. 4 again, as stated above, the display unit 30 may display the vehicle exterior around-view image I_{A} processed by means of the image delay and a total perspective image I_{T} formed by the under-vehicle image I_{U}. Briefly, through the vehicle exterior around-view image captured during driving of the vehicle and refunding to the under-vehicle image I_{U} after a delay time difference, the under-vehicle image I_{U} during the driving of the vehicle can present a transparent state, so that a road condition under a vehicle floor may be easily viewed. Therefore, problems such as: a relative relationship between a tire and a road border; when a road surface is uneven, a relative relationship between the tire and the low-lying road surface; and when driving at a low speed, whether animals (cat, dog, or little animals) suddenly appear under the vehicle can all be resolved.

Referring to FIG. 2 again, the travel path F in this embodiment is moving forward, through a D gear signal of a gear device 40 (for example: a shift lever or a paddle shifter), the image delay processing unit 22 may be enabled to capture the delayed images (I_{D1-D3}) divided by the front image I_{F}, and refund the delayed images (I_{D1-D3}) onto the under-vehicle image I_{U}. Certainly, a person skilled in the art can deduce that if the travel path F is moving back, through an R gear signal of the gear device 40, the image delay processing unit 22 may be enabled to capture delayed images (not shown in this figure) divided by the back image, and refund the delayed images onto the under-vehicle image I_{U}. However, image delay processing technologies when the travel path F is turning left or turning right have the same logic, and details are not described in detail herein.

Referring to FIG. 2 and FIG. 4 again, the total perspective image in this embodiment is a two-dimensional (2D) image. A person skilled in the art can deduce that the total perspective image may convert the two-dimensional (2D) image into a three-dimensional (3D) image through a reverse projection technology by using the image processing module 20. This technology is relatively mature, and details are not described in detail herein.

Referring to FIG. 2 and FIG. 4 again, the driving around-view auxiliary device 1 of the present invention may further include a memory 50 that can store the under-vehicle image I_{U} (that is, a perspective image) processed by means of the image delay when the vehicle is stalled, and restore the under-vehicle image I_{U} (that is, the perspective image) when the vehicle is started, so that a driver can see a perspective image under the vehicle floor when the vehicle is started.

In addition, a person skilled in the art can deduce that four virtual wheels (not shown in the figures) may be superposed on the under-vehicle image. In this way, a relative relationship between the wheel and the road surface or the obstacle is clearer.

In view of the above, the driving around-view auxiliary device provided in the present invention enables the under-vehicle image to be seen through by using the image delay processing technology, so that the road condition under the vehicle floor may be easily viewed. Therefore, the driver can understand relative relationships among the road surface, the tire, the road border, the road conditions, and an objective on the road surface without getting off to actually view, thereby greatly improving driving safety.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A driving around-view auxiliary device, applicable to a vehicle, wherein the device comprises:
a lens group, comprising a plurality of lenses, wherein these lenses are respectively disposed at different positions around the vehicle, to respectively capture a plurality of external images around the vehicle;
an image processing module electrically connected to the lens group, wherein the image processing module comprises:
an image splicing processing unit, receiving these external images and splicing and synthesizing the external images into a vehicle exterior around-view image, wherein an under-vehicle image is segmented in the vehicle exterior around-view image; and
an image delay processing unit, capable of dividing, according to a travel path of the vehicle, the vehicle exterior around-view image that overlaps the travel path into a plurality of delayed images, and sequentially attaching, according to a delay time, the delayed images on the under-vehicle image starting from the delayed image that is adjacent to the under-vehicle image; and
a display unit, electrically connected to the image processing module, and capable of displaying a total perspective image formed by the vehicle exterior around-view image processed by means of the image delay and the under-vehicle image.

2. The driving around-view auxiliary device according to claim 1, wherein these lenses comprise a front lens, a back lens, a left lens, and a right lens, and receive these external images of these lenses and correspondingly splice and synthesize these external images into the vehicle exterior around-view image that has a front image, a back image, a left image, and a right image.

3. The driving around-view auxiliary device according to claim 2, wherein the travel path is moving forward, and these delayed images are divided by the front image.

4. The driving around-view auxiliary device according to claim 2, wherein the travel path is moving back, and these delayed images are divided by the back image.

5. The driving around-view auxiliary device according to claim 1, wherein the total perspective image is capable of being a two-dimensional (2D) image.

6. The driving around-view auxiliary device according to claim 1, wherein the total perspective image is capable of being a three-dimensional (3D) image.

7. The driving around-view auxiliary device according to claim 1, further comprising a memory that is capable of storing the under-vehicle image processed by means of the image delay when the vehicle is stalled, and restoring the under-vehicle image when the vehicle is started.

8. The driving around-view auxiliary device according to claim 1, wherein four virtual wheels are capable of being superposed on the under-vehicle image.

9. The driving around-view auxiliary device according to claim 1, wherein the delay time is capable of being several seconds, and a quantity of these delayed images obtained through division is capable of being the same as a quantity of the seconds of the delay time.

10. The driving around-view auxiliary device according to claim 1, wherein these delayed images are at equal distances to an axial border of the under-vehicle image.
